(19) United States
(12) Patent Application Publication
(10) Pub. No.: US 2025/0183337 A1
(43) Pub. Date: Jun. 5, 2025

(54) SYSTEMS AND METHODS FOR DETERMINING SEQUENTIAL PRESSURE REGRESSION IN FUEL CELLS

(71) Applicant: Toyota Motor Engineering & Manufacturing North America, Inc., Plano, TX (US)

(72) Inventors: Hadi Mansourifar, Ann Arbor, MI (US); Chen Ling, Troy, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/524,196

(22) Filed: Nov. 30, 2023

(51) Int. Cl. H01M 8/04664; G06N 3/0464; G06T 7/254; G06V 10/25; G06V 10/44; G06V 10/75; G06V 10/778; H01M 8/04298; H01M 8/0438; H01M 8/04992

(52) U.S. Cl. CPC H01M 8/04671; G06T 7/254; G06V 10/25; G06V 10/44; G06V 10/751; G06V 10/778; H01M 8/04305; H01M 8/04395; H01M 8/04992; G06N 3/0464; G06T 2207/30164; H01M 2250/10; H01M 2250/20

(57) ABSTRACT

A system includes a high speed camera configured to capture sequential images of a cathode side backing layer of a test fuel cell during operation thereof, a processor, and a memory. The memory is communicably coupled to the processor and stores machine-readable instructions that, when executed by the processor, cause the processor to perform image pre-processing on the sequential images, detect water pixel anomalies in the pre-processed sequential images and provide pre-processed and anomaly detected sequential images, and train a machine learning model to predict pressure values in the test fuel cell using the pre-processed and anomaly detected sequential images.

### TECHNICAL FIELD

The present disclosure relates generally to fuel cells, and particularly to water control in fuel cells.

### BACKGROUND

Water formation and accumulation on the cathode of a fuel cell (also known as “water flooding”) are problematic for the operation and performance thereof. For example, water flooding on the cathode is known to result in pressure fluctuations and irregular air supply in air channels that provide oxygen to the cathode. Accordingly, real time monitoring of such water flooding can be beneficial to reduce or avoid decreasing fuel cell performance. However, known techniques for monitoring water flooding use extensive resources and/or equipment such as X-ray imaging and neutron scattering imaging. And even if water flooding can be determined in real time, its consequence on pressure fluctuations within the fuel can be challenging to probe or detect.

The present disclosure addresses issues related to water flooding and pressure fluctuations within fuel cells, and other issues related to fuel cells.

### SUMMARY

This section provides a general summary of the disclosure and is not a comprehensive disclosure of its full scope or all of its features.

In one form of the present disclosure, a system includes a high speed camera configured to capture sequential images of a cathode side backing layer of a test fuel cell during operation thereof, a processor, and a memory. The memory is communicably coupled to the processor and stores machine-readable instructions that, when executed by the processor, cause the processor to perform image pre-processing on the sequential images, detect water pixel anomalies in the pre-processed sequential images and provide pre-processed and anomaly detected sequential images, and train a machine learning model to predict pressure in the test fuel cell using the pre-processed and anomaly detected sequential images.

In another form of the present disclosure, a system includes a high speed camera configured to capture sequential images of a cathode side backing layer of a test fuel cell during operation thereof, a processor, and a memory communicably coupled to the processor. The memory includes stored machine-readable instructions that, when executed by the processor, cause the processor to perform image pre-processing on the sequential images, detect water pixel anomalies in the pre-processed sequential images and provide pre-processed and anomaly detected sequential images, apply a pre-defined mask to the pre-processed and anomaly detected sequential images, train a machine learning model to predict pressure in the test fuel cell using the masked pre-processed and anomaly detected sequential images, and predict a pressure value for the test fuel cell.

In still another form of the present disclosure, a system includes a high speed camera configured to capture sequential images of a cathode side backing layer of a test fuel cell during operation thereof, a processor, and a memory. The memory is communicably coupled to the processor and stores machine-readable instructions that, when executed by the processor, cause the processor to perform various desired functions. In some variations, the desired functions include performing image pre-processing on the sequential images and detecting water droplets as anomalous pixels surrounded by humidity and vapor pixels in the pre-processed sequential images and providing pre-processed and anomaly detected sequential images that comprise the extracted features with water vapor and background humidity pixels removed therefrom. In at least one variations, the desired functions also include applying a pre-defined mask to the pre-processed and anomaly detected sequential images, training a machine learning model to predict pressure in the test fuel cell using the masked pre-processed and extracted water pixels and their population at each channel, and training a pressure regression model to predict the pressure in a real fuel cell.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 shows a polymer electrolyte membrane (PEM) fuel cell;

FIG. 2 shows a block diagram for a system for a fuel cell water management according to the teachings of the present disclosure;

FIG. 3 shows a block diagram for a processing module according to the teachings of the present disclosure;

FIG. 3A shows a block diagram for a pre-processing module according to the teachings of the present disclosure;

FIG. 3B shows a block diagram for an anomaly detection module according to the teachings of the present disclosure;

FIG. 3C shows a block diagram for a mask design module according to the teachings of the present disclosure;

FIG. 3D shows a block diagram for a sequential processing module according to the teachings of the present disclosure;

FIG. 3E shows a block diagram for a model evaluation module according to the teachings of the present disclosure;

FIG. 4 is a flow chart for a method according to the teachings of the present disclosure;

FIG. 5A illustrates an optical image of a cathode side back plate with flow channels viewed through a transparent frame;

FIG. 5B is a subtracted image of the optical image in FIG. 5A;

FIG. 5C is a dilution image of the subtracted image in FIG. 5B;

FIG. 5D is an erosion image of the dilution image in FIG. 5C;

FIG. 5E is the erosion image in FIG. 5D after pixel-wise anomaly detection;

FIG. 5F is a mask applied to the optical image in FIG. 5A;

FIG. 5G is the mask in FIG. 5F applied to the erosion image with pixel-wise anomaly detection in FIG. 5E;

FIG. 6A is a graphical plot expected and predicted normalized pressure values as a function of time during operation of fuel cell according to the teachings of the present disclosure;

FIG. 6B is another graphical plot expected and predicted normalized pressure values as a function of time during operation of fuel cell according to the teachings of the present disclosure;

FIG. 6C is still another graphical plot expected and predicted normalized pressure values as a function of time during operation of fuel cell according to the teachings of the present disclosure;

FIG. 7A is a graphical plot of the expected versus predicted normalized pressure values for the FIG. 6A;

FIG. 7B is a graphical plot of the expected versus predicted normalized pressure values for the FIG. 6B; and

FIG. 7C is a graphical plot of the expected versus predicted normalized pressure values for the FIG. 6C.

### DETAILED DESCRIPTION

The present disclosure provides real time monitoring of fuel cell water flooding using optical camera imaging and provides a method and/or system to estimate the effect of water flooding on oxygen pressure in the cathode side of the fuel cell. In some variations, computer vision and machine learning approaches are used to replace complex numerical analysis for pressure prediction in actual fuel cell channels. The system and methods disclosed herein address a significant challenge in pressure prediction in fuel cell channels, particularly, the presence of noise in captured images of curved-shape channel geometries and surrounding areas, which inhibit distinguishing between dark pixels representing water droplets and dark pixels representing background noise. For example, in some variations the present disclosure teaches a mask-based approach to ignore background noise and treat water droplets inside each channel separately. In addition, the present disclosure provides for estimating the pressure drop in fuel cell channels and the ability to correlate water formation with pressure increases in the fuel cell. As used herein, the term “pixel” refers to the smallest unit or element of an image.

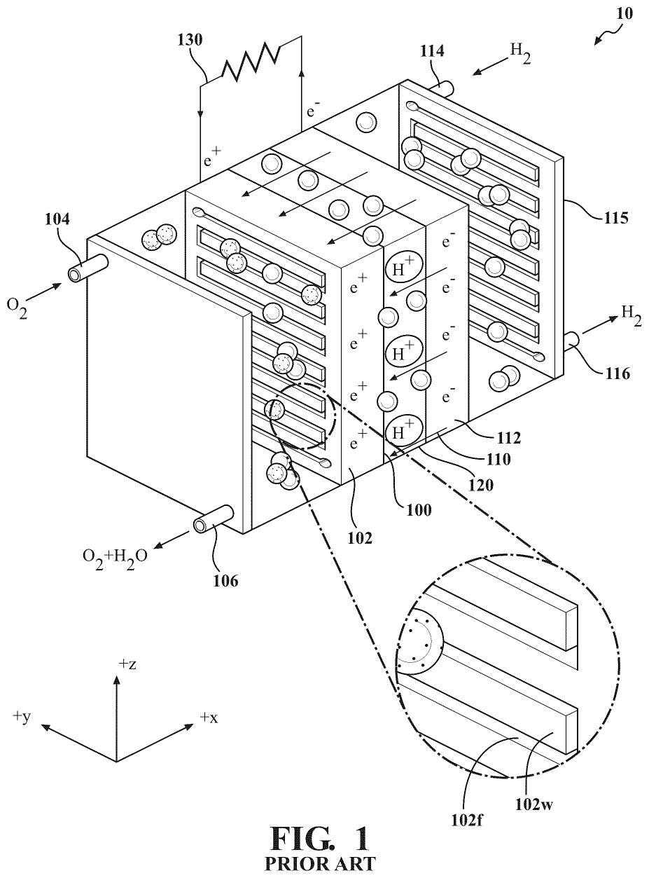

Referring to FIG. 1, a simplified perspective and exploded view of a PEM fuel cell 10 (also referred to herein simply as “fuel cell”) is shown. The fuel cell 10 includes a cathode 100, an anode 110, and a polymer electrolyte membrane 120 disposed between the cathode 100 and the anode 110. The fuel cell 10 also includes a cathode side backing layer 102 with one or more oxygen flow channels 102f (also referred to herein simply as “flow channels”) defined between flow channel walls 102w. The one or more flow channels 102f, in combination with a cathode side frame 105 having an inlet 104 and an outlet 106, provide for oxygen (e.g., O₂ in air) to enter the fuel cell 10 and flow into contact with the cathode 100. Similarly, an anode side backing layer 112 with one or more flow channels (now shown) defined between flow channel walls (not shown) in combination with an anode side frame 115 having an inlet 114 and outlet 116 provide for hydrogen (H₂) to be provided to the anode 110.

In operation, and with respect to the anode side of the fuel cell 10, hydrogen is provided and flows into contact with the anode 110 via the inlet 114 of the anode side frame 115 and the flow channels of the anode side backing layer 112. The hydrogen is catalyzed into H⁺ ions and electrons (e⁻), the H⁺ ions migrate through the polymer electrolyte membrane 120, and the electrons migrate through an external circuit 130 to the cathode 100. Regarding the cathode side of the fuel cell 10, oxygen is provided and flows into contact with the cathode 100 the inlet 104 of the cathode side frame 105 and the flow channels 102f of the cathode side backing layer 102. The oxygen reacts with the H⁺ ions and electrons at the cathode 100 to form water (H₂O), and heat, such that electrical power is generated by the fuel cell 10. And while the by-products of the fuel cell 10 are only oxygen and water, the formation of water at the cathode 100 can block or reduce the amount of additional oxygen that can contact the cathode 100, and thereby reduce or inhibit operation and/or efficiency of the fuel cell 10. Accordingly, the present disclosure provides for enhanced techniques and/or methods for monitoring water formation on the cathode side of a fuel cell such that water flooding is reduced or prevented in an efficient manner. As used herein, the phrase “water flooding” refers to the formation and accumulation of water in the flow channels 102f.

Not being bound by theory, and while it is advantageous to remove water from the cathode side of the fuel cell, use of excess air and/or ultrasonic energy to remove the water decreases the efficiency of the fuel cell 10. Stated differently, it is desirable to remove water from the flow channels 102f and/or fuel cell 10 only when desired, i.e., not to use energy to expel water when not needed.

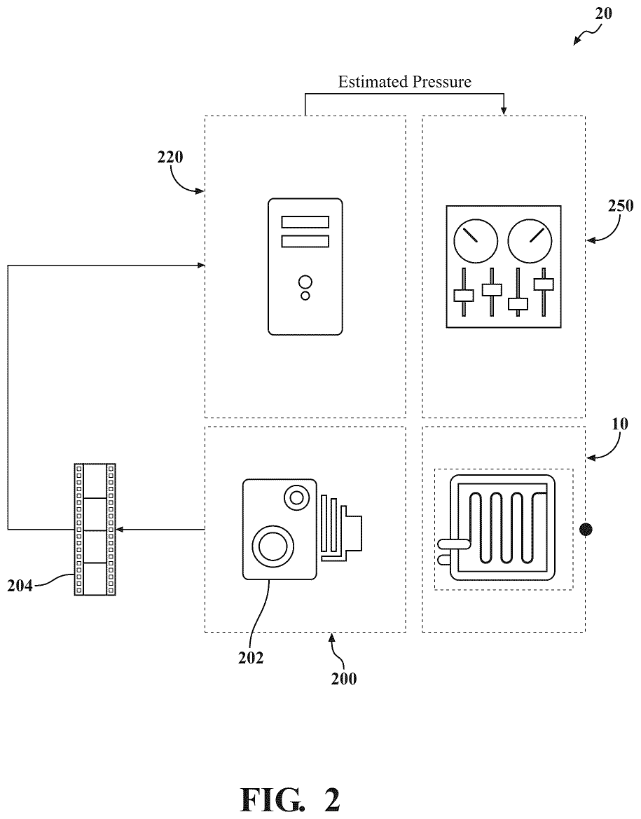

Referring to FIG. 2, a system 20 for predicting and managing water flooding in the fuel cell 10 (also referred to herein as a “test fuel cell 10”) according to one form of the present disclosure is shown. The system 20 includes a data collection module 200, a controller 220 in communication with the data collection module 200, and optionally a control module 250 that receives output from the controller 220 and is configured to control or manage water flooding in the test fuel cell 10. Stated differently, in at least one variation the system 20 does not include the control module 250 and output from the controller 220 is exported and provided to an external control module configured to control or manage water flooding in one or more additional fuel cells. And in at least one other variation, the system includes the control module 250, and optionally one or more additional fuel cells.

In some variations, the data collection module 200 includes an optical camera 202, e.g., a high-speed optical analog or high-speed digital camera, configured to capture sequential images 204 (e.g., sequential digital images) of the cathode side backing layer 102 (FIG. 1). For example, in at least one variation the cathode side frame 105 is transparent and the optical camera captures images of the cathode side back layer 102 during operation of the test fuel cell 10. In addition, the controller 220 is configured to pre-process the captured images 204, execute pixel-wise anomaly detection of the pre-processed images, design a mask for the pre-processed images, and develop a pressure regression model for the test fuel cell 10. The pressure regression model, once developed (e.g., trained), estimates a pressure value in the flow channels 102f as a function of water content in the flow channels 102f. That is, the pressure regression model estimates a pressure value in the flow channel 102f of the cathode side backing layer 102 as a function of water content in the flow channel 102f as determined by the controller 220. Also, the estimated pressure value can be or is provided to the control module 250, or another control module of another fuel cell, such that the control module(s) can take action to remove water, adjust pressure, etc., in the fuel cell 10 and/or other fuel cells.

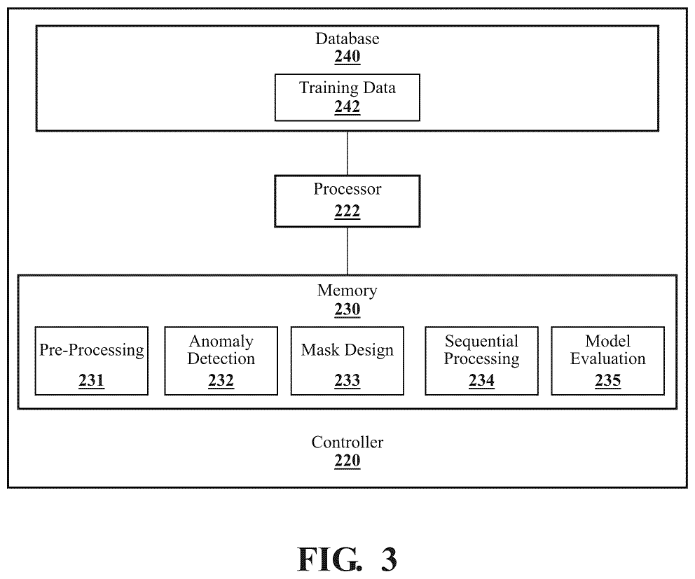

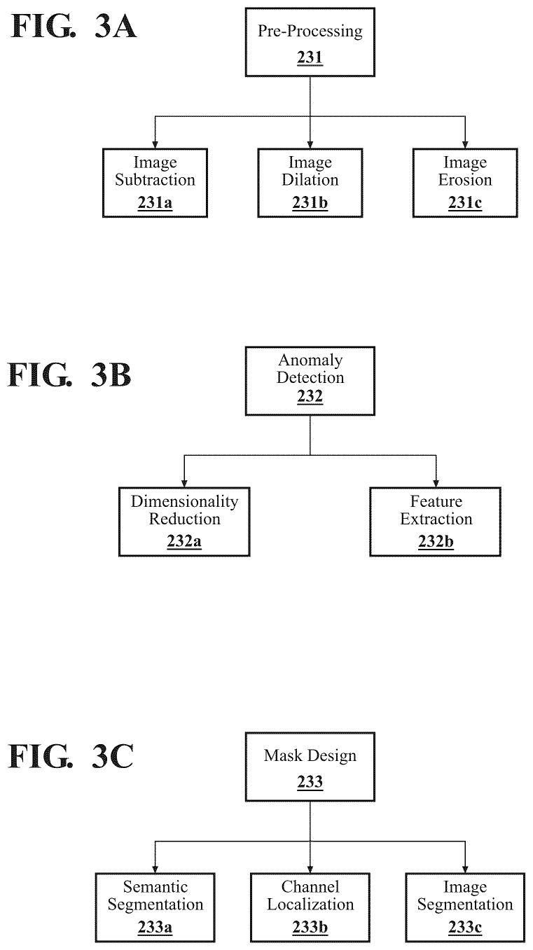

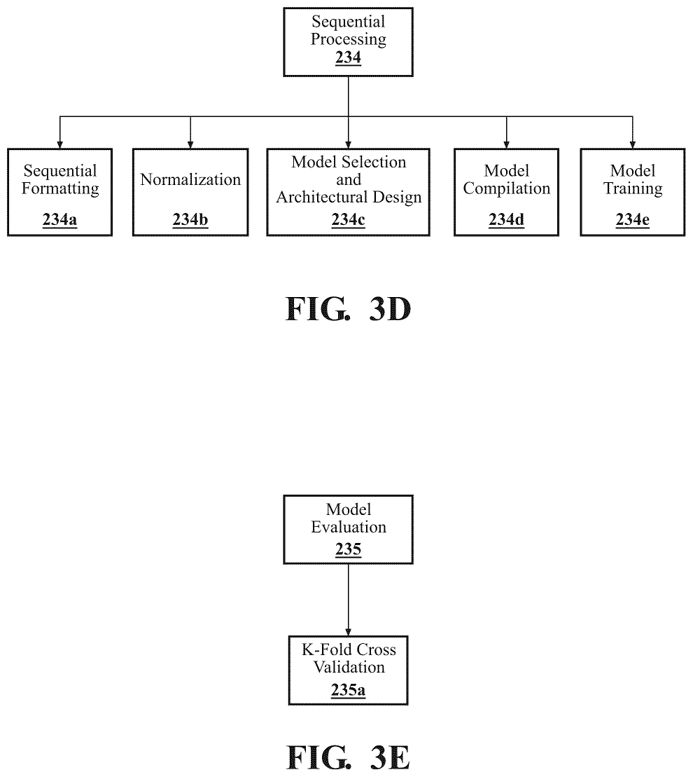

Referring to FIG. 3, a block diagram for the controller 220 according to one form of the present disclosure is shown. The controller 220 can include a processor 222, a memory 230, and a database 240. The processor 222 may be a part of the controller 220, the controller 220 may include a separate processor from the processor 222 of system 20, or the controller 220 may access the processor 222 through a data bus or another communication path.

The memory 230 stores a pre-processing module 231, an anomaly detection module 232, a mask design module 233, a sequential processing module 234, and a model evaluation module 235 such that the memory 230, provides for image processing of captured images received from the data collection module 200 and machine learning (ML) of a pressure regression that occurs in a fuel cell during operation as described in greater detail below. The memory 230 can be constructed as a random-access memory (RAM), read-only memory (ROM), a hard-disk drive, a flash memory, or other suitable memory for storing the pre-processing module 231, anomaly detection module 232, mask design module 233, sequential processing module 234, and model evaluation module 235. The pre-processing module 231, anomaly detection module 232, mask design module 233, sequential processing module 234, and model evaluation module 23, for example, can be constructed as computer-readable instructions that when executed by the processor 222 cause the processor 222 to perform the various functions disclosed herein.

The database 240 stores, among other things, training data 242 (e.g., experimental pressure values versus water accumulation data). In some variations, the database 240 is constructed as an electronic data structure stored in the memory 230 or another data store, such as a cloud-based storage, a removable memory device, or another suitable location that is accessible to the sequential processing module 234 and/or the model evaluation module 235. The database 240 is configured with routines that can be executed by the processor 222 for analyzing stored data, providing stored data, organizing stored data, and so on. And in at least one variation, the database 240 stores data described above (as well as other data) used by the sequential processing module 234 and/or the model evaluation module 235 to execute various functions.

Referring to FIG. 3A, in some variations, the pre-processing module 231 is generally constructed including instructions that function to control the processor to execute image processing of the captured images 204, e.g., to execute image subtraction, image dilation, and/or image erosion on the captured images 204. As used herein, the phrase “imaging processing” refers to the process of transforming an image into a digital form or digital image if the image is not originally a digital image, and preforming algorithmic operations on the digital image in order to obtain useful information from the digital image. For example, the pre-processing module 231 can include an image subtraction module 231a, an image dilation module 231b, and/or an image erosion module 231c. As used herein, the phrase “image subtraction” refers to subtracting a captured (digital) image from a base image and the phrase “base image” refers to a captured image of a dry cathode side backing plate 102 with no water or water droplets in the flow channels 102f. Also, the phrase “image dilation” refers to adding pixels to a subtracted image (e.g., adding pixels to the boundaries of objects in a captured image) such that background pixels are “boosted” and noise is reduced. And the phrase “image erosion” refers to removing pixels from a dilated image to “boost” object pixels impacted by the noise reduction executed by image dilution. In addition, as used herein the term “noise” refers to artifacts that do not originate from an original captured image.

Accordingly, the image subtraction module 231a functions to control the processor 222 to subtract the captured images 204 from the base image, extract pixels with high potential of being categorized as water droplets from the captured images 204, and thereby provide “subtraction” images. The image dilation module 231b functions to control the processor 222 to boost background pixels to reduce noise in the subtraction images provided by the image subtraction module 231a and thereby provide “dilation” images. And the image erosion module 231c functions to control the processor 222 to boost water droplet pixels in the dilation images impacted by the noise reduction executed by the image dilation module 231b and thereby provide “erosion” images.

Stated differently, and through the processor 222, the image subtraction module 231a transforms the pixels of features (feature pixels) in the captured images 204 into numerical features (also referred to herein as “subtraction pixels”) that can be processed while preserving the information in the original feature pixels. The image dilation module 231b boosts background pixels of the subtraction images to reduce noise in the subtraction pixels. And the image erosion module 231c boosts water pixels in the dilation images that were effected or impacted by the noise removal executed by the image dilation module 231b. Accordingly, pre-processing of the captured images 204 with the image subtraction module 231a, the image dilation module 231b, and the image erosion module 231c provides or results in pre-processed images with enhanced detection and imaging of water (e.g., water droplets) in the flow channels 102f of the cathode side backing layer 102.

Referring to FIG. 3B, in some variations the anomaly detection module 232 functions to control the processor 222 to distinguish between water vapor and water droplets in the flow channels 102f, e.g., via dimensionality reduction and feature extraction. That is, it should be understood that water vapor in the flow channels 102f can be imaged similarly to water droplets by the camera 202, i.e., water vapor pixels can appear as water droplet pixels. In addition, image processing of the captured images 204 may not desirably distinguish between water vapor pixels and water droplet pixels in the captured images, subtraction images, dilation images, and/or erosion images. However, water vapor is a compressible gas, water droplets are an uncompressible liquid, and distinguishing between water vapor and water droplets is desirable for enhanced pressure determination and/or water management in a fuel cell. Accordingly, the anomaly detection module 232 is configured to execute pixel-wise anomaly detection of the pre-processed image(s) provided by the pre-processing module 231, and in doing so, more precisely detects or identifies water droplets.

In at least one variation, the anomaly detection module 232 includes a dimensionality reduction module 232a and/or a feature extraction module 232b such that pixelwise anomaly detection of the pre-processed images using methods (algorithms) such as uncertainty estimation, outlier exposure, and image re-synthesis, among others, is provided. Pixelwise anomaly detection is a technique used in computer vision and image processing to identify unusual or anomalous regions within an image. Unlike traditional object detection, which focuses on detecting specific objects or patterns, pixelwise anomaly detection seeks to find individual pixels or small regions (also known as anomalous pixel counts) that deviate significantly from the expected norm in an image such that such anomalous pixel counts can be extracted from an image.

Referring to FIG. 3C, in some variations the mask design module 233 functions to control the processor 222 to localize and/or segment specific objects or regions within the captured images 204. For example, in at least one variation the mask design module 233 includes a semantic segmentation module 233a that functions to control the processor 222 to provide precise object localization and boundary delineation between the flow channels 102f and flow channel walls 102w of the cathode side backing layer 102. Also, in some variations the mask design module 233 includes a channel localization module 233b that functions to control the processor 222 to define exact or nearly exact pixels that belong to the flow channels 102f and/or the flow channel walls 102w of the cathode side backing layer 102, and thereby enable enhanced identification and feature extraction of the flow channel walls 102w. And in at least one variation, the mask design module 233 includes an image segmentation module 233c that functions to control the processor 222 to assign a label to every pixel such that the captured images 204 are divide into subgroups of pixels known as image segments.

Referring to FIG. 3D, in some variations the sequential processing module 234 functions to control the processor 222 to estimate a pressure value(s) in the test fuel cell 10 (i.e., in the flow channels 102f) as a function of water content (i.e., water pixels) in the flow channels 102f via methods or techniques such as sequential formatting, normalization, machine learning (ML) model selection and architecture design, ML model compilation, and/or ML model training. For example, and as illustrated in FIG. 3D, the sequential processing module 234 can include a sequential formatting module 230a that functions to control the processor 222 to order the pre-processed and anomaly detected images in a specific sequence of time series. The sequential processing module 234 can also include a normalization module 234b that functions to control the processor 222 to change values of the pre-processed and anomaly detected images (i.e., pixels of the pre-processed and anomaly detected images) to a common scale without distorting differences in the range of values of the pixels or losing information from the pixels.

In some variations, the sequential processing module 234 includes a ML model selection and architecture design module 234c that functions to control the processor 222 to select a ML model from a plurality of availably ML models (e.g., stored in the memory 230) and design (program) the selected ML model. In at least one variation, the sequential processing module 234 includes a ML model compilation module 234d that functions to control the processor 222 to check for formatting errors, define a loss function, define an optimizer or learning rate, and/or define metrics of the ML model selected by the ML model selection and architecture design module 234c. For example, the ML model training module 234e can train the ML model using experimentally determined pressure values as a function of water content for one or more fuel cells. Stated differently, measured pressure values as a function of water content in flow channels of a fuel cell determined using x-ray imaging or neutron scattering imaging can be used to train the ML model. In the alternative, in some variations, selecting and designing a ML model is provided by an outside or third party resource, and ML model is simply incorporated in and/or provided to the sequential processing module 234.

Referring to FIG. 3E, in some variations the sequential processing module 234 includes a model evaluation module 235 that functions to control the processor 222 to validate the results or output of the ML model. For example, the model evaluation module 235 can include a K-fold cross validation module 235a configured to evaluate the ML model by dividing the training data into “k” sets or folds, where each “fold” is a pre-processed and anomaly detected image, and the ML model is trained and evaluated k times using a different fold as the validation set each time.

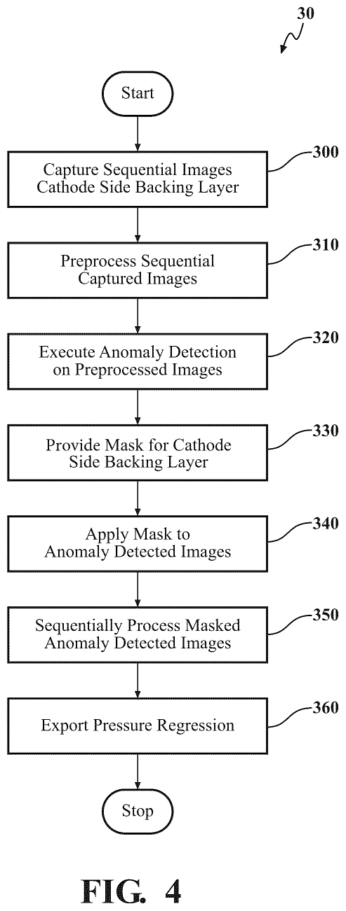

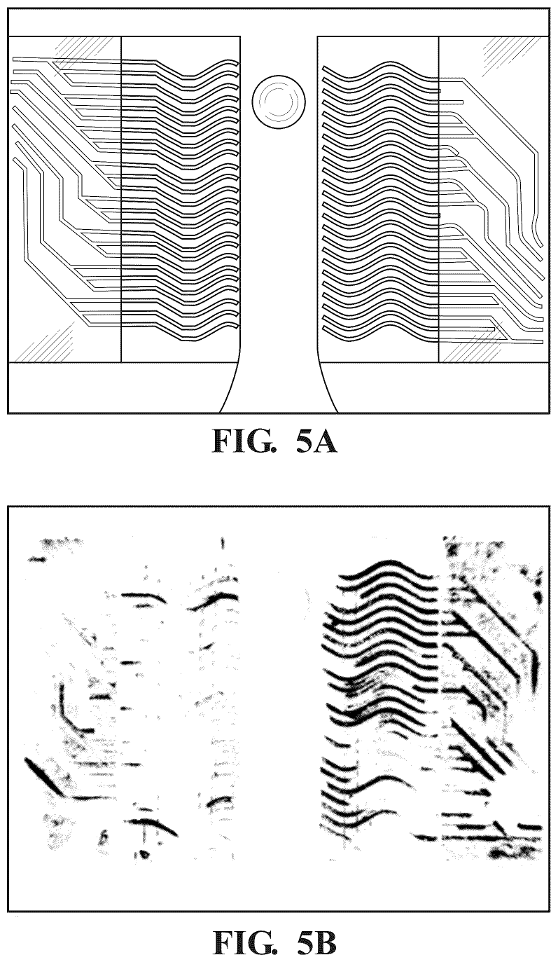

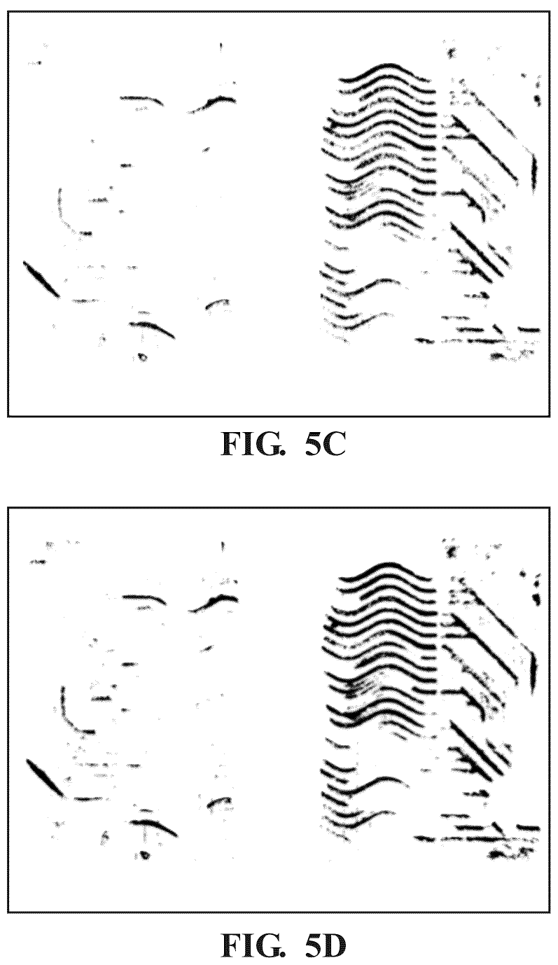

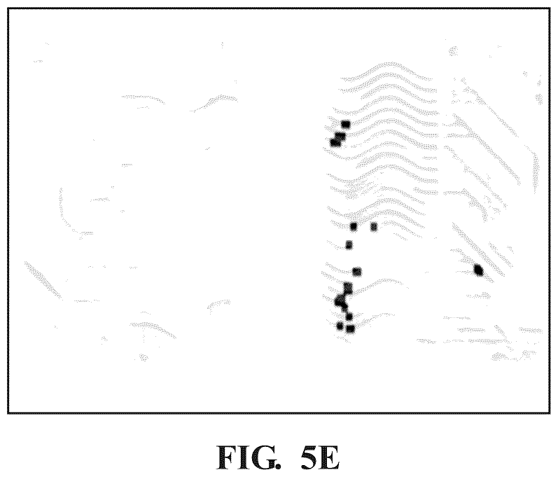

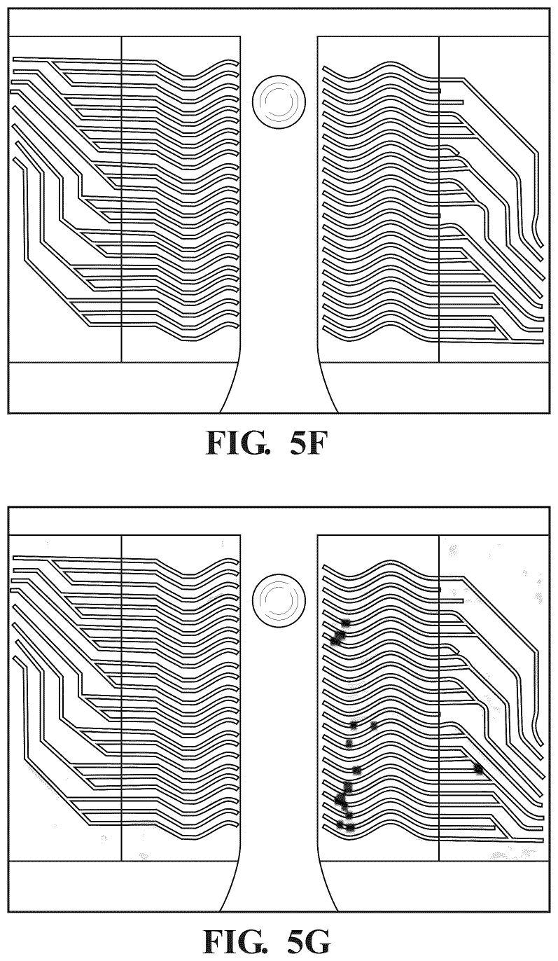

Referring to FIGS. 4 and 5A-5G, a flow chart for a method 30 for using the system 20 according to one form of the present disclosure is shown in FIG. 4 and actual images taken and provided by the system 20 are shown in FIGS. 5A-5G. The method 30 includes capturing time sequential images of the flow channels (e.g., using the data collection module 200) in a fuel cell cathode side backing layer during operation of the fuel cell. In some variations, the fuel cell has a transparent frame that allows for optical images to be captured of the flow channels as a function of time. One such optical image is illustrated in FIG. 5A, and as observed in the image, flow channels and flow channel walls of the cathode side backing plate are visible. In addition, one of the captured images can be a “base image” of the flow channels, i.e., an image of the flow channels when water droplets are not present.

After and/or during capturing of the sequential images, the method 30 pre-processes the sequential captured images at 310. For example, in some variations the image subtraction module 231a (FIG. 3A) functions to control the processor 222 to execute image subtraction on the input image shown in FIG. 5A and thereby obtain the subtracted image shown in FIG. 5B. Also, the subtracted image shown in FIG. 5B can be processed with the image dilation module 231b to remove noise from the subtracted image and provide the diluted image shown in FIG. 5C. And the diluted image shown in FIG. 5C can be processed with the image erosion module 231c to boost water droplet pixels and provide the erosion image shown in FIG. 5D. Accordingly, the method 30 provides enhanced identification and counting of dark pixels (i.e., water droplet pixels) within the flow channels of the cathode side backing layer.

The method 30 executes anomaly detection of the pre-processed image shown in FIG. 5E at 320 such that water vapor pixels (shown as light grey pixels in FIG. 5E) are distinguished from water droplet pixels (shown as black pixels in FIG. 5E) and an anomaly detected image is provided. In addition, the water vapor pixels can be removed from the pre-processed image such that pre-processed and anomaly detected images are provided. Before during or after pre-processing of the sequential captured images at 310 and/or executing anomaly detection at 320, the method 30 provides a mask for the cathode side backing layer at 330. For example, in some variations the input image shown in FIG. 5A is processed with the mask design module 233 to provide and apply a mask such that a supervised label is provided or applied to each flow channel 102f. In the alternative, a mask is designed by an individual such that a supervised label is provided or applied to each flow channel 102f. In any event, the mask shown in FIG. 5F is applied to the pre-processed and anomaly detected image at 340 to provide a masked pre-processed and anomaly detected image as shown in FIG. 5G. It should be understood that the masked pre-processed and anomaly detected image allows or provides for enhanced identification and counting of water droplets within the flow channels 102f. And while FIG. 4 illustrates applying the mask to the pre-processed and anomaly detected image, it should be understood that the mask can be applied to the pre-processed images before anomaly detection, i.e., step 340 in FIG. 4 would go between step 310 and step 320.

The method 30 proceeds to 350 where sequential processing of the masked anomaly detected images occurs. For example, in some variations the sequential processing module 234 instructs the processor 222 to order the pre-processed and anomaly detected images in a specific sequence of time series (via sequential formatting module 234a), to change values of the masked anomaly detected images to a common scale without distorting differences in the range of values of the pixels or losing information from the pixels (via normalization module 234b), select and/or design a ML model (via ML model selection and architecture design module 234c), check for formatting errors, define a loss function, define an optimizer or learning rate, and/or define metrics of the selected ML model (via ML model compilation module 234d), train the ML model using training data (via ML model training module 234e and training data 242), and validate the ML model (via model evaluation module 235). In this manner, the sequential processing module 234 provides an estimated pressure regression (i.e., prediction of pressure values as a function of water accumulation) for the fuel cell.

In some variations, the ML model is an appropriate sequential neural network model, for example, a long short-term memory (LSTM) recurrent neural network or an LSTM recurrent neural network with a convolution operation inside the LSTM cell (ConvLSTM), among others. Also, designing the architecture of the ML model can include defining features such as the number of layers of the neural network, the number of hidden units in the neural network, and the activation functions for each layer of the neural network, among others. In addition, evaluation of the ML model can include using a k-fold cross validation module 235a where the masked anomaly detected images are divided into k subsets (where k is the number of masked anomaly detected images), and the ML model is trained and evaluated k times using a different subset as the test set and remaining subsets as the training set each time.

The method 30 also includes exporting the pressure regression to a controller of a fuel cell at 360. In some variations, the controller is for the fuel cell used to obtain the captured images, while in other variations the controller is for one or more different fuel cells. For example, in some variations the system 20 is used to develop a pressure regression using one or more fuel cells located in a testing laboratory, workshop, factory, etc., and the pressure regression is exported to a controller that controls water management for one or more fuel cells that provide electrical power to a vehicle (e.g., an electric vehicle). That is, the controller is part of the vehicle. In the alternative, the pressure regression is exported to a controller that controls water management for one or more fuel cells of a transportable or non-transportable power station.

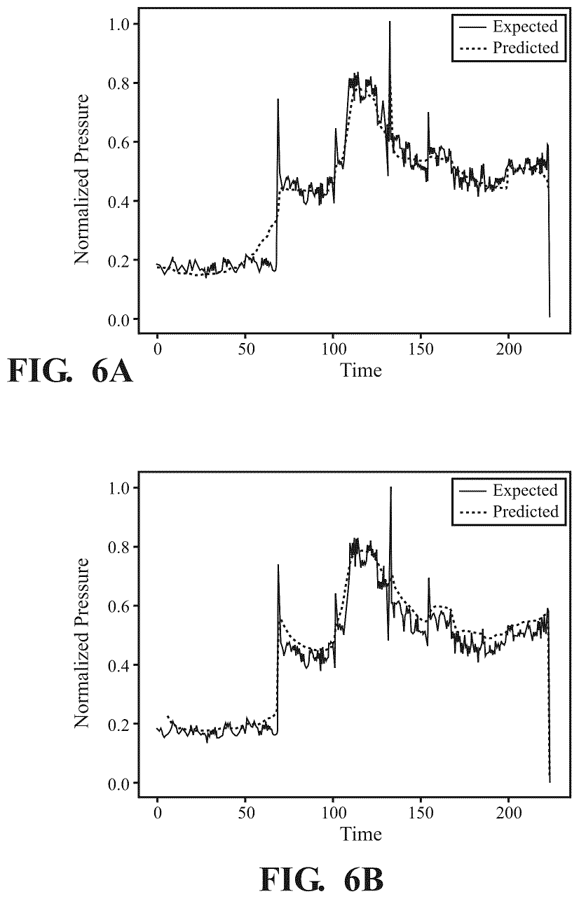

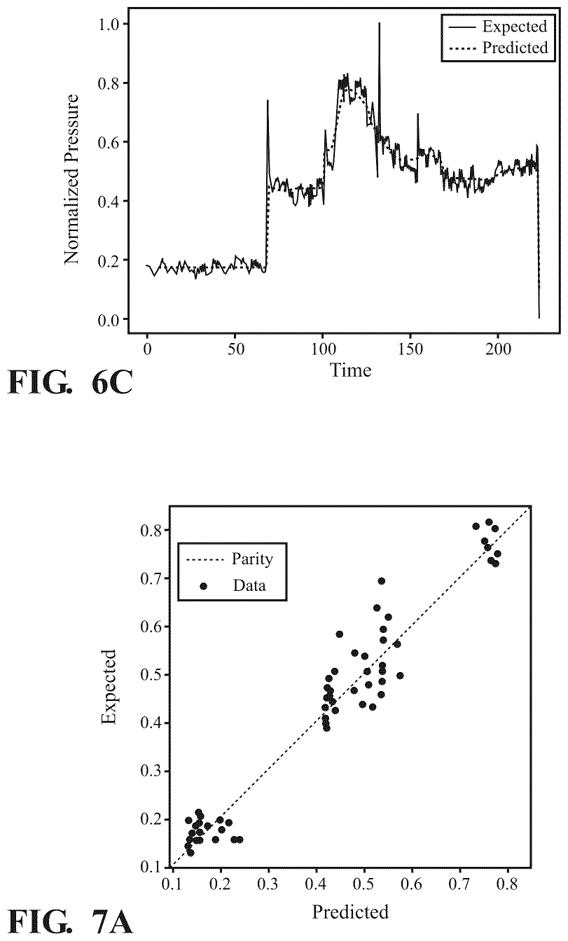

In an effort to better explain and embody the teachings of the present disclosure, but not limit the scope thereof in any manner, experimental results for three different methods of developing a pressure regression for a fuel cell are shown in FIGS. 6A-6C. Particularly, FIG. 6A illustrates expected or experimentally determined pressure values and predicted pressure values (normalized pressure values shown in the figures) as a function of fuel cell operation time (normalized time shown in the figures) using non-sequential color images (i.e., each image was considered as an independent input) to train the ML model discussed above. FIG. 6B illustrates expected and predicted pressure values as a function of fuel cell operation time using a current color image and six earlier sequential color images to train and test the ML model. And FIG. 6C illustrates expected and predicted pressure values as function of fuel cell operation time using a current masked pre-processed and anomaly detected image and six earlier masked pre-processed and anomaly detected images to train and test the ML model. And as illustrated by comparing FIG. 6C to FIGS. 6A-6B, the pressure regression predicted using the sequential masked pre-processed and anomaly detected images resulted in an increase in agreement between the expected (experimental) pressure regression and the predicted pressure regression.

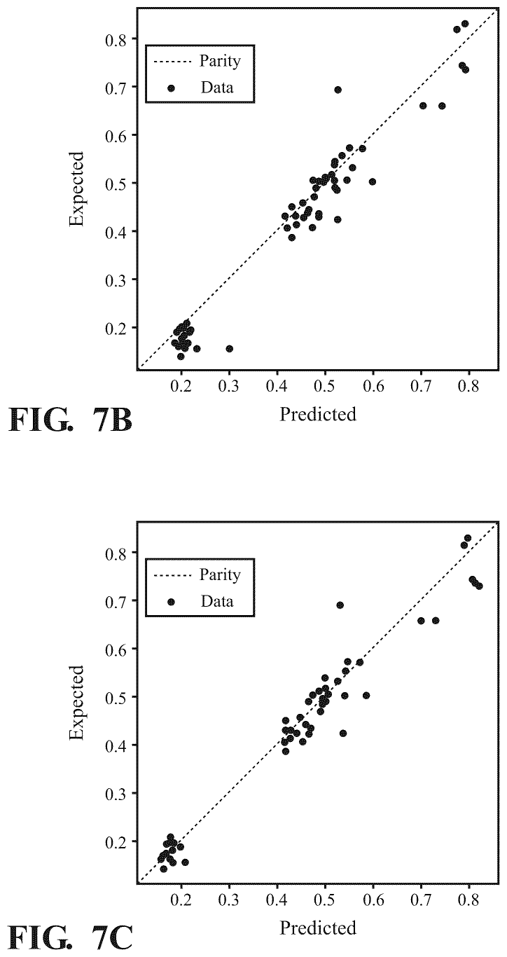

In addition, and with reference to FIGS. 7A-7C, statistical agreement of the three methods discussed above is shown. Particularly, FIG. 7A illustrates the statistical agreement of the expect and predicted pressure values for using non-sequential color images to train the ML model discussed above, FIG. 7B illustrates the expected and predicted pressure values for using sequential color images to train and test the ML model, and FIG. 7C illustrates the expected and predicted pressure values for using masked pre-processed and anomaly detected images to train and test the ML model. As observed by comparing FIG. 7C to FIGS. 7A-7B, the pressure regression predicted using the sequential masked pre-processed and anomaly detected images is statistically more accurate that the pressure regression predicted using the non-sequential color images or the sequential color images.

It should be understood from the teachings of the present disclosure that systems and methods that provide enhanced water flooding prediction and water flooding management of fuel cells are disclosed. The systems and method provide a pressure regression for a fuel cell and the pressure regression is then used for enhanced water flooding management of the fuel cell and/or other fuel cells. For example, the system can be used to develop and provide a pressure regression for any number of actual fuel cells in one location (e.g., a laboratory, factory, etc.), and the pressure regression can be used by or exported to a controller for the water flooding management of fuel cells in a second location (power station, electric vehicle, etc.). In this manner, enhanced efficiency and operation of the fuel cells is provided without the need for extensive, complicated, and/or expensive equipment such as x-ray and/or neutron imaging devices.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7C, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for conducting the methods described herein is suited. A typical combination of hardware and software can be a processing system with computer-usable program code that, when being loaded and executed, controls the processing system such that it conducts the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to conduct these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for conducting operations for aspects of the present arrangements may be written in any combination of one or more programming languages, including an object-oriented programming language such as Python, Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should be also understood that the various method steps discussed herein do not have to be conducted in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A system comprising:
an optical camera configured to capture sequential images of a cathode side backing layer of a test fuel cell during operation thereof;
a processor; and
a memory communicably coupled to the processor and storing machine-readable instructions that, when executed by the processor, cause the processor to:
perform image pre-processing on the sequential images;
detect water pixel anomalies in the pre-processed sequential images and provide extracted anomalous pixel counts; and
train a machine learning model to predict pressure values in the test fuel cell using the extracted anomalous pixel counts in captured sequential images.

2. The system according to claim 1, wherein the cathode side backing layer comprises oxygen flow channels and the optical camera is configured to capture optical images of the oxygen flow channels during operation of the test fuel cell.

3. The system according to claim 2, wherein the optical camera captures water accumulation in the oxygen flow channels during operation of the test fuel cell.

4. The system according to claim 3, wherein the image processing comprises image subtraction, image dilation, and image erosion on the sequential images.

5. The system according to claim 4, wherein detecting water pixel anomalies comprises dimensionality reduction and feature extraction of the pre-processed sequential images.

6. The system according to claim 5, wherein the memory stores machine-readable instructions that, when executed by the processor, cause the processor to apply a mask to the pre-processed and anomaly detected sequential images.

7. The system according to claim 6, wherein applying the mask on the pre-processed and anomaly detected sequential images provides a supervised label for each of the oxygen flow channels.

8. The system according to claim 1, wherein the machine learning model is a ConvLSTM recurrent neural network.

9. The system according to claim 1 further comprising a controller configured to control water flooding a fuel cell.

10. The system according to claim 9, wherein the processor exports an estimated pressure value for the test fuel cell to the controller and the controller controls water accumulation of the test fuel cell using the estimated pressure value.

11. The system according to claim 9, wherein the processor exports a pressure regression for the test fuel cell to the controller and the controller controls water accumulation of another fuel cell using the pressure regression.

12. The system according to claim 1, wherein the memory stores machine-readable instructions that, when executed by the processor, cause the processor to:
apply a mask to the pre-processed and anomaly detected sequential images and provide masked pre-processed and anomaly detected sequential images;
train the machine learning model to predict pressure in the test fuel cell using the masked pre-processed and anomaly detected sequential images; and
develop a pressure regression model for the test fuel cell.

13. The system according to claim 12, wherein the memory stores machine-readable instructions that, when executed by the processor, cause the processor to export the pressure regression model to a controller configured to manage water of a plurality of fuel cells.

14. The system according to claim 13, wherein the plurality of fuel cells comprise a plurality of electric vehicle fuel cells.

15. The system according to claim 13, wherein the plurality of fuel cells comprise a plurality of power station fuel cells.

16. A system comprising:
an optical camera configured to capture sequential images of a cathode side backing layer of a test fuel cell during operation thereof;
a processor; and
a memory communicably coupled to the processor and storing machine-readable instructions that, when executed by the processor, cause the processor to:
perform image pre-processing on the sequential images;
detect water pixel anomalies in the pre-processed sequential images and provide pre-processed and anomaly detected sequential images;
design and apply a mask to the pre-processed and anomaly detected sequential images;
train a machine learning model to predict pressure values in the test fuel cell using the masked pre-processed and anomaly detected sequential images; and
estimate a pressure value for the test fuel cell.

17. The system according to claim 16, wherein the memory stores machine-readable instructions that, when executed by the processor, cause the processor to remove water vapor pixels from the pre-processed sequential images.

18. The system according to claim 17, wherein the memory stores machine-readable instructions that, when executed by the processor, cause the processor to export the estimated pressure value to a controller configured to manage water of a plurality of fuel cells.

19. A system comprising:
an optical camera configured to capture sequential images of a cathode side backing layer of a test fuel cell during operation thereof;
a processor; and
a memory communicably coupled to the processor and storing machine-readable instructions that, when executed by the processor, cause the processor to:
perform image pre-processing on the sequential images;
detect water pixel anomalies in the pre-processed sequential images and provide pre-processed and anomaly detected sequential images that comprise the pre-processed sequential images with water pixels removed therefrom;
design and apply a mask to the pre-processed and anomaly detected sequential images;
train a machine learning model to predict pressure values in the test fuel cell using the masked pre-processed and anomaly detected sequential images; and
predict a pressure value for the test fuel cell.

20. The system according to claim 19, wherein the memory stores machine-readable instructions that, when executed by the processor, cause the processor to export the pressure value to a controller configured to manage water of a plurality of fuel cells.
